(19) United States
(12) Patent Application Publication
(10) Pub. No.: US 2025/0298467 A1
(43) Pub. Date: Sep. 25, 2025

(54) CONVERSATION APPARATUS

(71) Applicant: Honda Motor Co., Ltd., Tokyo (JP)

(72) Inventors: Sunao Yamaguchi, Tokyo (JP); Kaede Inoguchi, Tokyo (JP); Kaho Tonomura, Tokyo (JP)

(21) Appl. No.: 19/060,715

(22) Filed: Feb. 23, 2025

(30) Foreign Application Priority Data
Mar. 21, 2024 (JP) 2024-045220

(51) Int. Cl. G06F 3/01; B60R 1/29; G10L 25/78

(52) U.S. Cl. CPC G06F 3/013; B60R 1/29; G10L 25/78; B60R 2300/8006

(57) ABSTRACT

A conversation apparatus configured to support a conversation between occupants of a vehicle. The apparatus includes a microprocessor connected to: a camera configured to capture images of a first occupant and a second occupant of the vehicle, an audio input device, and a display device. The microprocessor is configured to perform: outputting an image of the second occupant captured by the camera to the first occupant via the display device; detecting an utterance of the first occupant by the audio input device; detecting a gaze of the first occupant based on an image of the first occupant captured by the camera; and outputting the image of the second occupant to the display device while the gaze of the first occupant directed toward the display device is being detected.

### CROSS-REFERENCE TO RELATED APPLICATION

This application is based upon and claims the benefit of priority from Japanese Patent Application No. 2024-045220 filed on Mar. 21, 2024, the content of which is incorporated herein by reference.

### BACKGROUND

### Technical Field

The present invention relates to a conversation apparatus configured to promote a conversation in a cabin of a vehicle.

### Related Art

As such a type of technology, a technology for facilitating a conversation between occupants seated apart, such as those in a front seat and a rear seat in a vehicle, has been developed. For example, JP 2016-63439 A discloses a technology in which a voice collected from an utterer is output from a speaker positioned at a position away from the utterer to allow a smooth conversation between occupants in a cabin of a vehicle.

However, in the technology disclosed in JP 2016-63439 A, each occupant can hear the voice of the other party, but in a case where a listening side does not utter a voice to a speaking side, the speaking side feels uneasy, and as a result, the conversation is not continued. Therefore, a mechanism for promoting a conversation without feeling uneasy has been demanded by users.

### SUMMARY

An aspect of the present invention is a conversation apparatus configured to support a conversation between occupants of a vehicle. The apparatus includes a microprocessor connected to: a camera configured to capture images of a first occupant and a second occupant of the vehicle; an audio input device; and a display device. The microprocessor is configured to perform: outputting an image of the second occupant captured by the camera to the first occupant via the display device; detecting an utterance of the first occupant by the audio input device; detecting a gaze of the first occupant based on an image of the first occupant captured by the camera; and outputting the image of the second occupant to the display device while the gaze of the first occupant directed toward the display device is being detected.

### BRIEF DESCRIPTION OF DRAWINGS

The objects, features, and advantages of the present invention will become clearer from the following description of embodiments in relation to the attached drawings, in which:

FIG. 1 is a schematic diagram illustrating an example of an IVI system including a conversation apparatus;

FIG. 2 is a diagram illustrating an operation menu screen;

FIG. 3A is a block diagram illustrating a configuration of a main part of the conversation apparatus;

FIG. 3B is a block diagram illustrating a configuration of a main part of a terminal;

FIG. 3C is a block diagram illustrating a configuration of a main part of a vehicle sensor group and a vehicle cabin camera;

FIG. 3D is a block diagram illustrating a configuration of a main part of an input device and an output device; and

FIG. 4 is a flowchart for describing an example of conversation support processing by a program.

### DETAILED DESCRIPTION OF THE INVENTION

An embodiment of the invention will be described below with reference to the drawings.

### <Outline of Conversation Apparatus>

A conversation apparatus according to the embodiment supports and promotes a conversation of occupants in a cabin of a moving vehicle such as an automobile. It is assumed that a plurality of persons (for example, four persons) including a driver are in the cabin. The conversation apparatus supports a conversation in the cabin with an expectation of promoting a conversation for a family member, an acquaintance, or the like who rides together to enjoy while moving to a destination.

As an example, a scene where both an occupant in a front seat in the cabin and an occupant in a rear seat in the cabin are seated while facing a traveling direction of the vehicle, and a figure of the occupant in the rear seat is not within a field of view of the occupant in the front seat is assumed. Then, it is assumed that the occupant in the front seat speaks to the occupant in the rear seat while facing the traveling direction. At this time, the occupant in the front seat does not know a reaction of the occupant in the rear seat, and thus, the occupant in the front seat feels uneasy about whether or not his/her voice has reached the rear seat or whether the occupant in the rear seat has listened to his/her voice, and as a result, the conversation may not continue.

In the scene as described above, the conversation apparatus supports the conversation for the occupant in the front seat when the occupant in the front seat speaks to the occupant in the rear seat. For example, the figure (for example, the face) of the occupant in the rear seat is displayed (projected in the case of a projection unit) on a display unit (or the projection unit) that is within the field of view of the occupant in the front seat. With such support, the reaction of the occupant in the rear seat is conveyed to the occupant in the front seat via the display unit (projection unit), so that the occupant in the front seat can continue the conversation without feeling uneasy. As a result, a conversation in the cabin can be promoted.

As described above as the outline, the conversation apparatus provides a service for promoting a conversation in which the occupant does not feel uneasy.

In the embodiment, the conversation apparatus is provided as one of functions of an in-vehicle infotainment (IVI) system provided in the vehicle. Such a conversation apparatus will be described in more detail.

### <System Configuration Example>

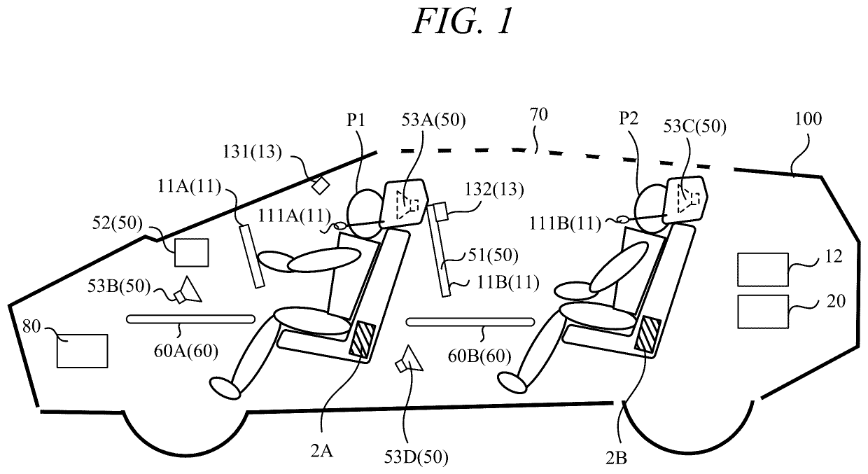

FIG. 1 is a schematic diagram illustrating an example of the IVI system including the conversation apparatus. The IVI system includes a control apparatus 20, a vehicle sensor group 12 of a vehicle 100 serving as a moving body, a display unit 51, a projection unit 52, and voice reproducing units 53A to 53D included in an output device 50 provided in the vehicle 100, operation detection units 11A and 11B and microphones 111A and 111B included in an input device 11 provided in the vehicle 100, a front seat camera 131 and a rear seat camera 132 included in a vehicle cabin camera 13 provided in the vehicle 100, a terminal 2A used by an occupant P1 in a front seat of a cabin, and a terminal 2B used by an occupant P2 in a rear seat of the cabin.

The control apparatus 20 and the terminals 2A and 2B are configured to be capable of wireless communication. The control apparatus 20, the output device 50, the input device 11, the vehicle sensor group 12, and the vehicle cabin camera 13 are configured to be capable of wired communication using a controller area network (CAN) or the like.

The vehicle 100 includes an air-conditioning device 80 that adjusts temperature and humidity in the cabin, a lighting device 70 (which may also be referred to as a dimmable sunroof) that can adjust a lighting amount for the inside of the cabin by using dimmable glass covering substantially the entire ceiling of the cabin, and an ambient light 60A for the front seat and an ambient light 60B for the rear seat included in an illumination device 60.

As an example, the terminals 2A and 2B are implemented by smartphones or the like used by the occupants P1 and P2, respectively. Each of the terminals 2A and 2B may be held by a holder (not illustrated) installed on a seat on which each person is seated.

Although the two terminals 2A and 2B are illustrated as terminals used by the occupants P1 and P2, the actual number of terminals varies depending on the number of occupants. The number of terminals is four in a case where there are four occupants. In addition, the number of cameras in the vehicle cabin camera 13, the number of operation detection units and the number of microphones in the input device 11, and the number of display units, the number of projection units, and the number of voice reproducing units in the output device 50 may also appropriately vary depending on the number of occupants.

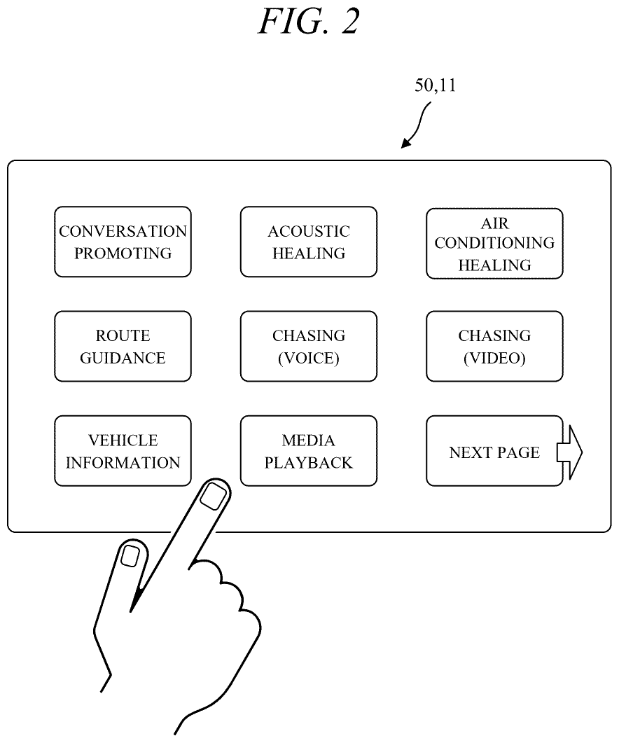

FIG. 2 is a diagram illustrating an operation menu screen of the IVI system of FIG. 1. In the embodiment, the operation menu screen is projected or displayed on the output device 50 (the projection unit 52 or the display unit 51). When a menu button (which may be referred to as an icon) displayed on the output device 50 is touched or a voice corresponding to the menu button is input from the microphones 111A and 111B included in the input device 11, the control apparatus 20 starts an operation of a function corresponding to the menu for which the touch operation has been made or the voice has been input.

The operation menu screen illustrated in FIG. 2 includes menu buttons corresponding to a “conversation promoting” function of supporting a conversation between the occupants of the vehicle 100, a “acoustic healing” function of soothing the occupants by reproduced sounds of the voice reproducing units 53A to 53D, an “air conditioning healing” function of soothing the occupants by using the air-conditioning device 80, a “route guidance” function of guiding a traveling route to a destination, a “chasing (voice)” function of connecting the terminal of the occupant who gets off the vehicle 100 and a communication unit (described below) of the control apparatus 20 to transmit an external voice to the occupant in the cabin, a “chasing (video)” function of connecting the terminal of the occupant who gets off the vehicle 100 and the communication unit (described below) of the control apparatus 20 to transmit an external video to the occupant in the cabin, a “vehicle information” function of performing function setting of the vehicle 100, an auxiliary machine operation, and the like, a “media playback” function of reproducing a medium in which a content is recorded from the output device 50, and other functions (not described).

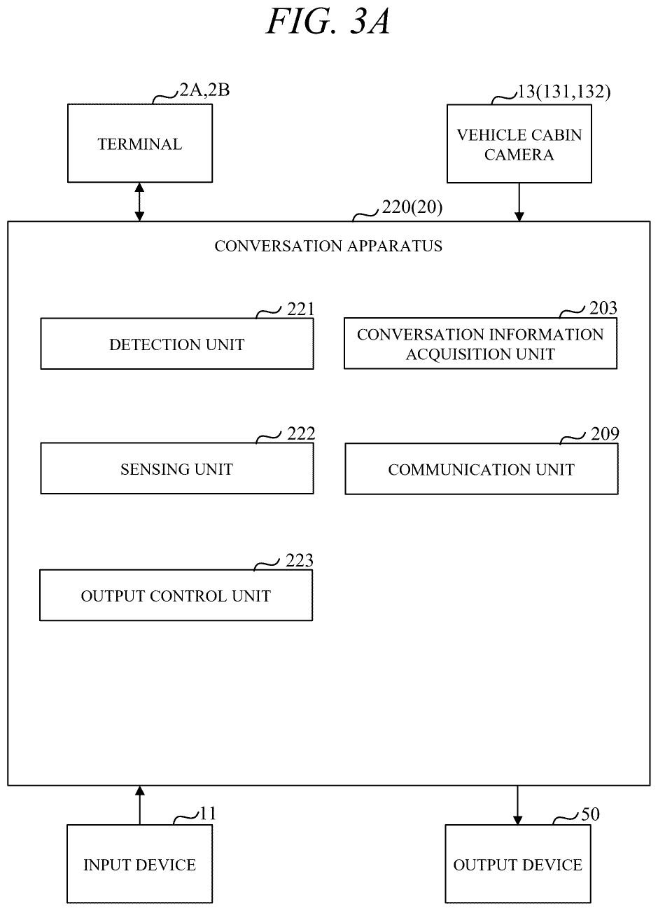

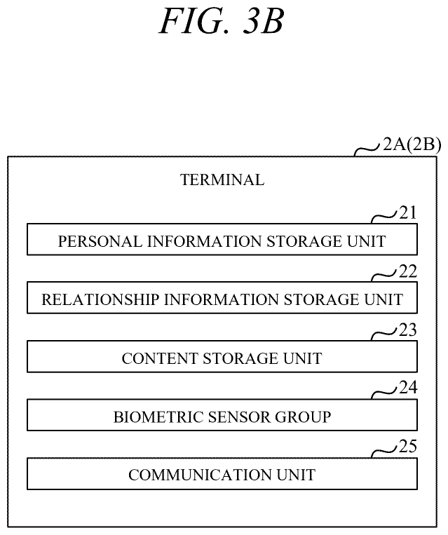

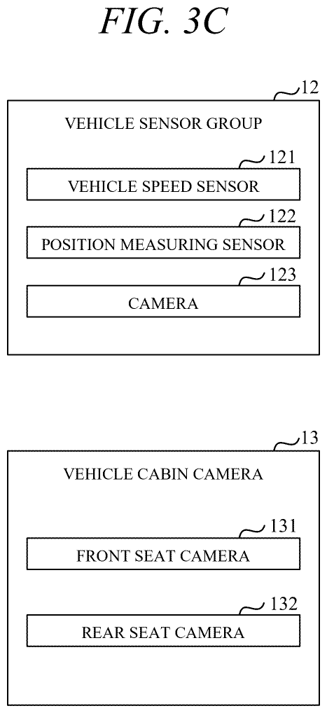

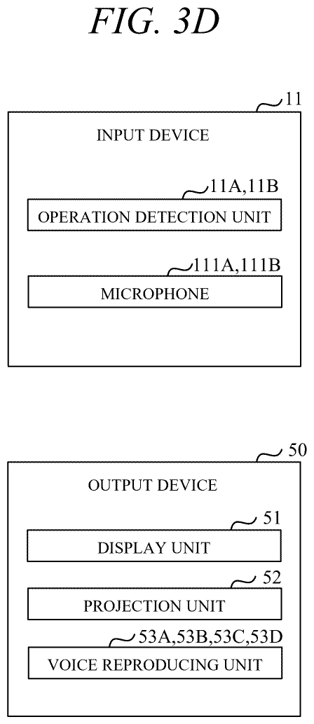

Hereinafter, a function of the control apparatus 20 as the conversation apparatus in a case where the “conversation assist” button on the operation menu screen is operated will be mainly described. FIGS. 3A to 3D are diagrams for describing a configuration example of each unit in FIG. 1.

### <Conversation Apparatus>

FIG. 3A is a block diagram illustrating a configuration of a main part of the control apparatus 20. The control apparatus 20 includes an arithmetic processing unit such as a micro processing unit (MPU) (not illustrated) and reads and executes a predetermined program stored in a storage unit (not illustrated) to perform various types of information processing, control processing, and the like necessary for the control apparatus 20.

The control apparatus 20 includes, as a functional configuration for a conversation apparatus 220, a conversation information acquisition unit 203, a communication unit 209, a detection unit 221, a sensing unit 222, and an output control unit 223, and performs control such that the IVI system functions as the conversation apparatus 220.

In the embodiment, as an example, when the occupants P1 and P2 get on the vehicle 100, the control apparatus 20 talks to the occupants P1 and P2 via the voice reproducing units 53A to 53D included in the output device 50, the microphones 111A and 111B included in the input device 11 collect voices (for example, names of the occupants P1 and P2 uttered by the occupants P1 and P2) as responses from the occupants P1 and P2, and the front seat camera 131 and the rear seat camera 132 included in the vehicle cabin camera 13 image the occupants P1 and P2.

The control apparatus 20 links (associates) the faces of the occupants P1 and P2, the names of the occupants P1 and P2, and frequency components of the voices uttered by the occupants P1 and P2 with one another.

### (Conversation Information Acquisition Unit)

The conversation information acquisition unit 203 acquires a conversation between the plurality of occupants P1 and P2 in the cabin as conversation information in a state in which the occupants P1 and P2 can be specified. When voice signals are input from the microphones 111A and 111B included in the input device 11, the conversation information acquisition unit 203 recognizes contents of utterances of the occupants P1 and P2 by using, for example, technologies such as voice recognition and natural language processing based on the input voice signals. As a result, the conversation information acquisition unit 203 determines that the conversation information has been acquired, at least in a case where the conversation information can be recognized as a language.

Furthermore, the conversation information acquisition unit 203 specifies an utterer based on the frequency components of the voice signals input from the microphones 111A and 111B. The utterer is specified by comparing the frequency components of the voice signals of the occupants P1 and P2 associated when the occupants P1 and P2 get on the vehicle 100 with the frequency components of the voice signals acquired as the conversation information.

### (Detection Unit)

The detection unit 221 detects gazes of the occupants P1 and P2 based on image information from the vehicle cabin camera 13 (the front seat camera 131 and the rear seat camera 132). For example, a non-moving portion (reference point) and a moving portion (moving point) of the eye of each person are found from the image, and the gaze is detected based on a position of the moving point with respect to the reference point.

In the embodiment, a state in which the gaze of the occupant P1 is positioned on a projected image projected by the projection unit 52 (in other words, a state in which the gaze of the occupant P1 is directed to the projected image projected by the projection unit 52) is detected based on the gaze of the occupant P1 detected by the detection unit 221. In addition, a state in which the gaze of the occupant P2 is positioned on a display screen displayed by the display unit 51 (in other words, a state in which the gaze of the occupant P2 is directed to the display screen displayed by the display unit 51) is detected based on the gaze of the occupant P2 detected by the detection unit 221.

When the conversation information acquisition unit 203 acquires the conversation information, the detection unit 221 detects the conversation information as the utterances of the occupants P1 and P2.

### (Sensing Unit)

The sensing unit 222 senses seating positions of the occupants P1 and P2 based on the image information from the vehicle cabin camera 13 (the front seat camera 131 and the rear seat camera 132). The control apparatus 20 can determine whether the occupants P1 and P2 are seated only on the front seats, separately seated on the front seat and the rear seat, or seated only on the rear seats based on the image information from the vehicle cabin camera 13.

### (Output Control Unit)

The output control unit 223 causes the projection unit 52 to project an image of the occupant P2 while the detection unit 221 detects the gaze of the occupant P1 directed to the projection unit 52 functioning as the display unit for the occupant P1 in the front seat and the utterance of the occupant P1. The image information captured by the rear seat camera 132 is used as the image of the occupant P2.

In addition, the output control unit 223 causes the display unit 51 to display an image of the occupant P1 while the detection unit 221 detects the gaze of the occupant P2 directed to the display unit 51 and the utterance of the occupant P2. The image information captured by the front seat camera 131 is used as the image of the occupant P1.

### (Communication Unit)

The communication unit 209 includes a short-range wireless communication module (not illustrated) that performs wireless communication with the terminals 2A and 2B and a wired communication module (not illustrated) that performs wired communication by the CAN or the like. A wireless communication system having a direction sensing function may be adopted as the short-range wireless communication module.

### <Terminal>

FIG. 3B is a block diagram illustrating a configuration of a main part of the terminal 2A. Since a configuration of the terminal 2B is similar to that of the terminal 2A, illustration thereof is omitted. The terminal 2A includes an arithmetic processing unit such as an MPU (not illustrated), and reads and executes a predetermined program (which may also be referred to as an application) stored in a storage unit (not illustrated) to perform various types of information processing, control processing, and the like necessary for a functional configuration described below.

The terminal 2A includes, as the functional configuration, a personal information storage unit 21, a relationship information storage unit 22, a content storage unit 23, a biometric sensor group 24, and a communication unit 25. In general, a smartphone includes a display unit, an input unit, a voice reproducing unit, a camera, a position detection unit, and the like, but illustration and description thereof are omitted.

The terminal 2A may share a function with another device such as a smart watch (not illustrated).

### (Personal Information Storage Unit)

The personal information storage unit 21 stores personal information of the occupant P1 who possesses the terminal 2A. In a case where the IVI system functions as the conversation apparatus 220, the personal information is not necessary.

### (Relationship Information Storage Unit)

The relationship information storage unit 22 stores relationship level information of the occupant P1 using the terminal 2A. In a case where the relationship level information indicating the degree of intimacy between the occupants P1 and P2 in the cabin is transmitted from the control apparatus 20, the relationship information storage unit 22 stores the relationship level information. In a case where the IVI system functions as the conversation apparatus 220, the relationship level information is not necessary.

### (Content Storage Unit)

The content storage unit 23 stores a content collected by the occupant P1 who possesses the terminal 2A or information (for example, a cloud storage that stores a content or a URL of a server that streams and reproduces a content) necessary for reproducing a content. In a case where the IVI system functions as the conversation apparatus 220, the content or the like described above is not necessary.

### (Biometric Sensor Group)

The biometric sensor group 24 includes, for example, a heart rate sensor that acquires a heart rate of the occupant P1 who possesses the terminal 2A, a respiration sensor that acquires a respiration rate, a blood flow rate sensor that acquires a blood flow rate, and a skin electrical resistance sensor that acquires a skin electrical resistance value (all the sensors described above are not illustrated). In a case where the IVI system functions as the conversation apparatus 220, biological information collected by the biometric sensor group 24 is not necessary.

### (Communication Unit)

The communication unit 25 includes a short-range wireless communication module (not illustrated) that performs wireless communication with the control apparatus 20 and a wired communication module (not illustrated) that performs wired communication by the CAN or the like.

FIG. 3C is a block diagram illustrating configurations of main parts of the vehicle sensor group 12 and the vehicle cabin camera 13 of the vehicle 100.

### <Vehicle Sensor Group>

The vehicle sensor group 12 includes a vehicle speed sensor 121, a position measuring sensor 122, and a camera 123. In general, an acceleration sensor, a radar, and the like are mounted as sensors on the vehicle 100, but illustration and description thereof are omitted.

### (Vehicle Speed Sensor)

The vehicle speed sensor 121 detects a vehicle speed of the vehicle 100 and outputs vehicle speed information to the control apparatus 20. In a case where the IVI system functions as the conversation apparatus 220, the vehicle speed information is not necessary.

### (Position Measuring Sensor)

The position measuring sensor 122 detects a current position of the vehicle 100 based on a positioning signal from a global positioning system (GPS) satellite, a quasi-zenith satellite, or the like. The position measuring sensor 122 outputs a signal indicating the current position to the control apparatus 20 as position information. In a case where the IVI system functions as the conversation apparatus 220, the information indicating the current position is not necessary.

### (Camera)

The camera 123 images the surroundings of the vehicle 100. The camera 123 outputs data of a subject image to the control apparatus 20 as image information. The camera 123 can capture still images and videos. In a case where the IVI system functions as the conversation apparatus 220, the image information of the surroundings of the vehicle 100 is not necessary.

### <Vehicle Cabin Camera>

The vehicle cabin camera 13 includes the front seat camera 131 and the rear seat camera 132. The front seat camera 131 images the upper body of the occupant P1 seated in the front seat, and outputs data of the subject image to the control apparatus 20 as the image information. The rear seat camera 132 images the upper body of the occupant P2 seated in the rear seat, and outputs data of the subject image to the control apparatus 20 as the image information.

FIG. 3D is a block diagram illustrating configurations of main parts of the input device 11 and the output device 50 of the vehicle 100.

### <Input Device>

The input device 11 includes the operation detection units 11A and 11B and the microphones 111A and 111B.

### (Operation Detection Unit)

The operation detection unit 11A is operated by the occupant P1 in the front seat, and outputs an operation signal to the control apparatus 20. The operation detection unit 11A may be implemented as a pointing device that is operated in conjunction with the projected image projected by the projection unit 52 described below. The operation detection unit 11B is provided on a display surface of the display unit 51. The operation detection unit 11B is operated by the occupant P2 in the rear seat and outputs an operation signal indicating a touch position to the control apparatus 20.

### (Microphone)

The microphone 111A collects the voice uttered by the occupant P1 in the front seat and outputs the voice signal to the control apparatus 20. The microphone 111B collects the voice uttered by the occupant P2 in the rear seat and outputs the voice signal to the control apparatus 20.

### <Output Device>

The output device 50 includes the display unit 51, the projection unit 52, and the voice reproducing units 53. The output device 50 is used, for example, for displaying the operation menu screen of FIG. 2, reproducing a content, and the like.

The content to be reproduced may be acquired from the terminals 2A and 2B possessed by the plurality of occupants P1 and P2 in the cabin via the communication unit 209. The content may be acquired not only from the terminals 2A and 2B but also from an external content management server via a communication network (not illustrated). The content management server includes a cloud storage that stores a content and a streaming server that reproduces a content. The content to be reproduced is searched and acquired by the control apparatus 20 via the communication unit 209.

Note that the content to be reproduced may be a video content (a moving image, a still image, text display, icon display, graphic display, or the like) or a sound content. The sound content includes a voice content and a music content.

### (Display Unit)

The display unit 51 includes a screen such as a liquid crystal display, and displays the image information based on a display signal output from the control apparatus 20. The image information includes the operation menu screen of FIG. 2, an image of the video content, and the like.

### (Projection Unit)

The projection unit 52 is implemented by, for example, a head-up display (HUD) to be projected on a windshield or the like, and projects the image information based on a projection signal output from the control apparatus 20. The image information includes the operation menu screen of FIG. 2, the image of the video content, and the like.

### (Voice Reproducing Unit)

The voice reproducing units 53A to 53D are implemented as speakers that reproduce and output the voice and the like, and reproduce the sound content based on a reproduction signal output from the control apparatus 20. Note that a sound output unit that outputs a content reproduction signal to a headphone (not illustrated) or the like may be provided.

### <Description of Flowchart>

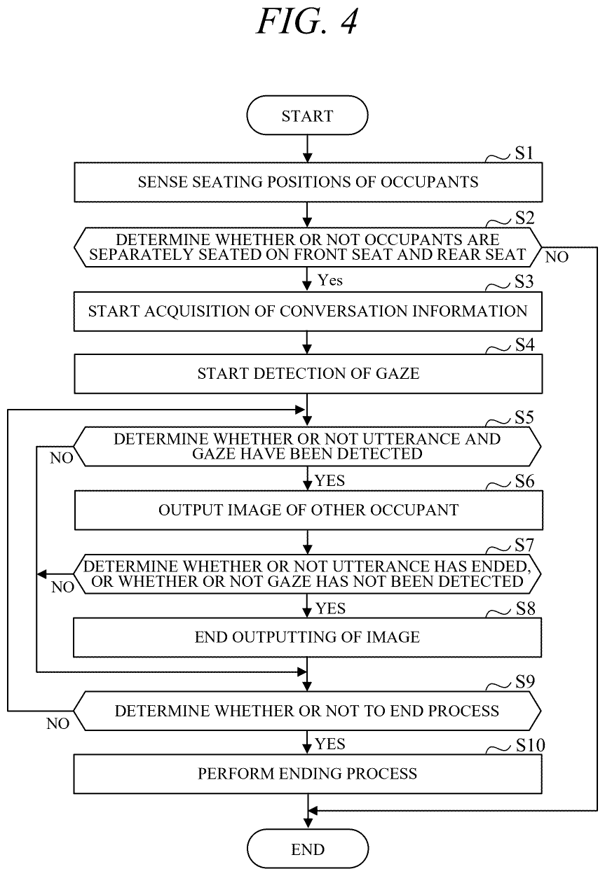

FIG. 4 is a flowchart for describing an example of conversation support processing by the program executed by the MPU of the control apparatus 20. When the “conversation assist” button is operated on the operation menu screen of FIG. 2, the MPU of the control apparatus 20 executes a program for performing the processing illustrated in FIG. 4 in order to cause the IVI system to function as the conversation apparatus 220. The control apparatus 20 functions as a control unit of the conversation apparatus 220 during execution of the program.

In step S1 of FIG. 4, the control apparatus 20 causes the sensing unit 222 to sense the seating positions of the occupants P1 and P2 in the cabin of the vehicle 100, and proceeds to step S2.

In step S2, the control apparatus 20 determines whether or not the occupants P1 and P2 are separately seated on the front seat and the rear seat based on a sensing result of the sensing unit 222. In a case where the occupants P1 and P2 are separately seated on the front seat and the rear seat, the control apparatus 20 makes an affirmative determination in step S2 and proceeds to step S3. At this time, the image of the other occupant (the occupant P2 for the occupant P1 and the occupant P1 for the occupant P2) is output to each of the projection unit 52 functioning as the display unit for the occupant P1 and the display unit 51 for the occupant P2.

In a case where the occupants P1 and P2 are not separately seated on the front seat and the rear seat, the control apparatus 20 makes a negative determination in step S2 and ends the processing of FIG. 4. The reason why the processing of FIG. 4 is ended in a case where a negative determination is made in step S2 is based on the idea that, when the occupants P1 and P2 are seated only on the front seats or only on the rear seats, a reaction of the occupant P2 can be recognized by the occupant P1 who has made an utterance, and thus the conversation support processing after step S4 does not need to be continued.

In step S3, the control apparatus 20 causes the conversation information acquisition unit 203 to start acquisition of the conversation information of the plurality of occupants P1 and P2 in the cabin, and proceeds to step S4.

In step S4, the control apparatus 20 causes the detection unit 221 to start detection of the gazes of the occupants P1 and P2 and proceeds to step S5.

In step S5, the control apparatus 20 determines whether or not the utterance of the occupant P1 or P2 and the gaze of the occupant P1 or P2 who has made the utterance have been detected, the gaze being directed to the display unit (the projection unit 52 or the display unit 51). In a case where the gaze of the occupant P1 directed to the projection unit 52 functioning as the display unit for the occupant P1 has been detected and the utterance of the occupant P1 has been detected, the control apparatus 20 makes an affirmative determination in step S5 and proceeds to step S6. In addition, also in a case where the gaze of the occupant P2 directed to the display unit 51 for the occupant P2 has been detected and the utterance of the occupant P2 has been detected, the control apparatus 20 makes an affirmative determination in step S5 and proceeds to step S6.

In a case where the gaze of the occupant P1 directed to the projection unit 52 has not been detected or the utterance of the occupant P1 has not been detected, and the gaze of the occupant P2 directed to the display unit 51 has not been detected or the utterance of the occupant P2 has not been detected, the control apparatus 20 makes a negative determination in step S5 and proceeds to step S9.

In step S6, the control apparatus 20 outputs the image of the other occupant (the occupant P2 for the occupant P1 and the occupant P1 for the occupant P2) to the projection unit 52 functioning as the display unit for the occupant P1 or the display unit 51 for the occupant P2, and proceeds to step S7. As a result, the image of the occupant P2 captured by the rear seat camera 132 is displayed in real time for the occupant P1, and the image of the occupant P1 captured by the front seat camera 131 is displayed in real time for the occupant P2.

In step S7, the control apparatus 20 determines whether or not the utterance of the occupant P1 or P2 has ended, or whether or not the gaze of the occupant P1 or P2 who has made the utterance has not been detected, the gaze being directed to the display unit (the projection unit 52 or the display unit 51). In a case where the utterance of the occupant P1 has ended or the gaze of the occupant P1 directed to the projection unit 52 functioning as the display unit has not been detected, the control apparatus 20 makes an affirmative determination in step S7 and proceeds to step S8. In addition, also in a case where the utterance of the occupant P2 has ended or the gaze of the occupant P2 directed to the display unit 51 has not been detected, the control apparatus 20 makes an affirmative determination in step S7 and proceeds to step S8.

The control apparatus 20 determines that the utterance of the occupant P1 has ended in a case where a state in which the utterance of the occupant P1 is not detected continues for a predetermined time. In addition, the control apparatus 20 determines that the gaze of the occupant P1 directed to the projection unit 52 has not been detected in a case where a state in which the gaze of the occupant P1 directed to the projection unit 52 is not detected continues for a predetermined time. The control apparatus 20 determines that the utterance of the occupant P2 has ended and the gaze of the occupant P2 has not been detected in a similar manner. A method for determining that the utterance has ended and the gaze has not been detected is not limited thereto.

In a case where it is not determined that the utterance has ended or the gaze has not been detected for both of the occupant P1 and the occupant P2, the control apparatus 20 makes a negative determination in step S7 and proceeds to step S9.

In step S8, the control apparatus 20 ends the outputting of the image of the occupant (the occupant P2 for the occupant P1 and the occupant P1 for the occupant P2) to the projection unit 52 functioning as the display unit for the occupant P1 or the display unit 51 for the occupant P2, and proceeds to step S9. As a result, the displaying of the image of the occupant P2 captured by the rear seat camera 132 for the occupant P1 and the displaying of the image of the occupant P1 captured by the front seat camera 131 for the occupant P2 end.

In step S9, the control apparatus 20 determines whether or not to end the conversation support processing. In a case where a predetermined end operation is performed, the control apparatus 20 makes an affirmative determination in step S9 and proceeds to step S10, and in a case where the end operation is not performed, the control apparatus 20 makes a negative determination in step S9 and returns to step S5. In the case where the control apparatus 20 returns to step S5, the control apparatus 20 repeats the above-described processing and continues the conversation support processing.

In step S10, the control apparatus 20 performs end processing and ends the processing of FIG. 4. As an example, the end processing includes the end of the acquisition of the conversation information by the conversation information acquisition unit 203 and the end of the detection of the gazes of the occupants P1 and P2 by the detection unit 221.

According to the embodiment described above, the following effects are obtained.

(1) The conversation apparatus 220 that supports a conversation between the occupants of the vehicle 100 includes: the front seat camera 131 and the rear seat camera 132 serving as cameras that image the first occupant P1 and the second occupant P2 of the vehicle 100; the projection unit 52 serving as a display unit that displays, for example, the image of the second occupant P2 captured by the rear seat camera 132 for the first occupant P1; the detection unit 221 that detects the utterance of the first occupant P1 by the microphone 111A serving as audio input device and detects the gaze of the first occupant P1 based on the image of the first occupant P1 captured by the front seat camera 131; and the output control unit 223 serving as a control unit that causes the projection unit 52 to display the image of the second occupant P2 while the detection unit 221 detects the gaze directed to the projected image projected by the projection unit 52 and the utterance.

With such a configuration, it is possible to prevent an occupant (here, P1) speaking to an occupant (here, P2) whose face is not visible from often feeling uneasy during a conversation in the cabin due to the fact that a reaction of the other party (here, P2) cannot be recognized, thereby naturally promoting the conversation. That is, since the faces are not visible between the front seat and the rear seat, the reaction of the other party cannot be recognized, and thus, conversations easily break off. However, with the above configuration, a user feels as if the user is having a conversation face-to-face with the other party, which makes the conversation lively. In addition, when a gaze of an occupant (here, P1) is not directed to a display (here, the projected image projected by the projection unit 52) on the display unit and when there is no utterance of the occupant (here, P1), an image of the other party (here, the occupant P2) is not projected. Therefore, the occupant (here, P1) is prevented from falling into a feeling of being monitored by the other party (here, the occupant P2).

It is also possible to describe the configuration as follows by reversing the roles of the occupant P1 and the occupant P2. That is, the conversation apparatus 220 that supports a conversation between the occupants of the vehicle 100 includes: the front seat camera 131 and the rear seat camera 132 serving as cameras that image the first occupant P1 and the second occupant P2 of the vehicle 100; the display unit 51 that displays, for example, the image of the first occupant P1 captured by the front seat camera 131 for the second occupant P2; the detection unit 221 that detects the utterance and the gaze of the second occupant P2; and the output control unit 223 serving as a control unit that causes the display unit 51 to display the image of the first occupant P1 while the detection unit 221 detects the gaze directed to a displayed image on the display unit 51 and the utterance.

As a result, the user feels as if the user is having a conversation face-to-face with the other party, which makes the conversation lively. In addition, when a gaze of an occupant (here, P2) is not directed to the displayed image on the display unit 51 and when there is no utterance of the occupant (here, P2), an image of the other party (here, the occupant P1) is not displayed. Therefore, the occupant (here, P2) is prevented from falling into a feeling of being monitored by the other party (here, the occupant P1).

(2) In the conversation apparatus 220, the first occupant P1 and the second occupant P2 are seated on the front seat and the rear seat of the vehicle 100, respectively.

It can be said that conversations easily break off because the face of the other party is not visible between the front seat and the rear seat. However, in the embodiment, it is possible to naturally promote the conversation by preventing an occupant from often feeling uneasy due to the fact that a reaction of the other party cannot be recognized during the conversation, particularly in a state in which the occupants P1 and P2 are seated on the front seat and the rear seat of the vehicle 100.

(3) The conversation apparatus 220 further includes the sensing unit 222 that senses the seating positions of the first occupant P1 and the second occupant P2, and the output control unit 223 causes the projection unit 52 to end the projection of the image of the second occupant P2 when both the first occupant P1 and the second occupant P2 are seated on the front seats or both the first occupant P1 and the second occupant P2 are seated on the rear seats.

With such a configuration, it is possible to perform projection by the projection unit 52 or display by the display unit 51 only in a state in which the seating positions of the occupants P1 and P2 are divided into the front seat and the rear seat. It is possible to prevent one occupant (for example, P2) from falling into a feeling of being monitored by the other occupant (for example, P1) unlike a case where the projection by the projection unit 52 or the display by the display unit 51 is always performed.

The above embodiment can be modified in various manners. Hereinafter, modified examples will be described.

### First Modified Example

In the above embodiment, an example of displaying (projecting) an image of the other party on the display unit 51 and the projection unit 52 in the cabin has been described. Instead, for the occupant P1, an image of the other party may be displayed on a display unit (not illustrated) of the terminal 2A possessed by the occupant P1, and for the occupant P2, an image of the other party may be displayed on a display unit (not illustrated) of the terminal 2B possessed by the occupant P2.

In a first modified example, the control apparatus 20 transmits the image information of the occupant P1 seated on the front seat captured by the front seat camera 131 or the image information of the occupant P2 seated on the rear seat captured by the rear seat camera 132 to the terminal 2B or 2A via the communication unit 209.

According to the first modified example, it is possible to obtain the same effects as those of the embodiment even in a case where the terminal 2B and the terminal 2A are used instead of the display unit 51 and the projection unit 52 in the cabin.

### Second Modified Example

In the above embodiment, an example in which four persons including the driver are in the cabin has been described, but the number of occupants is not limited to four, and may be six or 10.

### Third Modified Example

According to the embodiment, the first modified example, and the second modified example described above, the vehicle 100 serving as the moving body has been exemplified as an example of the cabin in which conversation support is performed by the conversation apparatus 220. However, a cabin of a moving body on which a plurality of occupants board may be treated similarly to the cabin described above.

The above embodiment can be combined as desired with one or more of the above modifications. The modifications can also be combined with one another.

According to the present invention, it is possible to naturally promote a conversation by preventing an occupant from feeling uneasy.

Above, while the present invention has been described with reference to the preferred embodiments thereof, it will be understood, by those skilled in the art, that various changes and modifications may be made thereto without departing from the scope of the appended claims.

What is claimed is:

1. A conversation apparatus configured to support a conversation between occupants of a vehicle, the apparatus comprising
a microprocessor connected to: a camera configured to capture images of a first occupant and a second occupant of the vehicle, an audio input device, and a display device, wherein
the microprocessor is configured to perform:
detecting an utterance of the first occupant by the audio input device;
detecting a gaze of the first occupant based on an image of the first occupant captured by the camera; and
outputting an image of the second occupant captured by the camera to the first occupant via the display device while the gaze of the first occupant directed toward the display device is being detected.

2. The conversation apparatus according to claim 1, wherein
the microprocessor is further connected to a second display device different from the display device as a first display device,
the microprocessor is configured to further perform:
detecting an utterance of the second occupant by the audio input device; and
detecting a gaze of the second occupant based on the image of the second occupant captured by the camera, and
the microprocessor is configured to perform
the outputting including outputting the image of the second occupant to the first occupant via the first display device while the gaze of the first occupant directed toward the first display device and the utterance of the first occupant are being detected, and outputting the image of the first occupant to the second occupant via the second display device while the gaze of the second occupant directed toward the second display device and the utterance of the second occupant are being detected.

3. The conversation apparatus according to claim 1, wherein
the first occupant and the second occupant are seated on a front seat and a rear seat of the vehicle, respectively.

4. The conversation apparatus according to claim 1, wherein
the microprocessor is configured to further perform
sensing seating positions of the first occupant and the second occupant based on a captured image from the camera, and
ending the outputting of the image of the second occupant to the display device when a state where both the first occupant and the second occupant are seated either on a front seat or on a rear seat is sensed, based on the captured image.
